(19) United States
(12) Patent Application Publication
(10) Pub. No.: US 2002/0019804 A1
(43) Pub. Date: Feb. 14, 2002

(54) Method for providing financial and risk management

(76) Inventor: Robert E. Sutton, Englewood, CO (US)

Correspondence Address: Cochran & Collins LLP, Suite 230, 3555 Stanford Road, Fort Collins, CO, 80525, US

(21) Appl. No.: 09/896,705

(22) Filed: Jun. 29, 2001

Related U.S. Application Data
(60) Provisional application No. 60/214,936, filed on Jun. 29, 2000.

(51) Int. Cl. G06F 17/60

(52) U.S. Cl. 705/38; 705/39

(57) ABSTRACT

A method for marketing, assessing, underwriting, insuring and managing loans comprising marketing information and training for financial institutions, criteria for employment, credit history, and loan property type, insurance for loss limited by a predetermined amount, and tracking and servicing of a loan including collection and liquidation in the event of default. The invention further comprises status reporting, and liquidation of loans prior to expiration of the term of a loan.

### CROSS REFERENCE TO RELATED APPLICATIONS

This application is based upon and claims priority of U.S. provisional application No. 60/214,936 entitled Method for Providing Financial and Risk Management filed Jun. 29, 2000 by Robert E. Sutton.

### BACKGROUND OF THE INVENTION

a. Field of the Invention

The present invention pertains generally to financial systems and more specifically to management of financial transactions and risk associated with nonstandard loans.

b. Description of the Background

The automobile financing industry in the United States finances approximately $500 billion in annual automobile purchases. Purchases where the borrower has a limited credit history, low income, or credit problems comprise approximately 30% of the annual purchases. Loans in this category are referred to as non-standard loans. Past methods of financing non-standard loans have comprised obtaining funds, lending money, and when additional capital is needed, securitizing a pool of loans and selling the pool to investors. The viability of these past methods depends on the yield of the pool prior to securitization. Poor portfolio performance mayjeopardize the ability to securitize the pool. Further, once the pool is securitized, there is no assurance that the pool may be sold to investors because of potential variations in interest rates, economic trends, and other market factors. The risk and uncertainty of pooled loans may result in more reluctant investors and a requirement for higher returns on investment. The requirement for higher returns may result in higher interest rates to purchasers and may produce a higher likelihood of default because of higher payments. Further, loans with uncertainty require higher levels of management, customer interaction, and assessment. Additionally, individual loans that comprise the pool of loans may have been issued using different sets of rules and operating procedures. Non-uniform procedures increase the difficulty of assessing and managing a pool of loans and to determine what changes might be made to improve portfolio performance. As such, a new method for loan qualification, insurance, and loan management is needed.

### SUMMARY OF THE INVENTION

The present invention overcomes the disadvantages and limitations of the prior art by providing a system and method to assess, fund, manage, and insure non-standard loans and to market the system and method of the invention to financial lending institutions and to customers. Advantageously, the present invention provides predefined criteria for loan approval, protection to the lender against borrower default, and loan management services, allowing financial institutions to participate in non-standard market opportunities without the risk of prior methods and without requiring additional management capabilities.

The invention therefore may comprise a method for providing financial and risk management for financial institutions comprising developing a marketing strategy between a financial institution and a customer, implementing the market strategy by setting up a program including systems, procedures, and underwriting guidelines, training the financial institution in the use of the program, receiving a loan application from the financial institution on behalf of a customer and processing and underwriting a loan based on the loan application, insuring the loan against default of the loan by the customer; and managing the servicing and collecting of the loan on behalf of the financial institution.

The system and method of the present invention may be implemented by a financial services provider (FSP) in conjunction with a financial institution such as a credit union or bank, for example. A predefined set of criteria is applied to applicant information to determine if the applicant may qualify for one or more lending programs.

An applicant may apply for credit prior to selecting an automobile for purchase and a ‘credit ready’ card may be issued to an applicant to indicate that the applicant has been pre-approved for a specific loan amount, allowing the applicant to shop for automobiles that fall within the specific loan amount. Or an applicant may apply for credit after an automobile has been selected. When an approved applicant has selected an automobile for purchase, the automobile is evaluated using criteria of the present invention to determine asset value. Automobiles may be rejected depending on make, model, age, mileage, loan to book value, or other criteria. Once the applicant and automobile meet criteria, an audit is performed and final approval may be given. After final approval, a contract is sent to the financial institution for funding. Funds are then provided to the automobile seller, to the FSP, and to purchase insurance that protects the financial institution against loss in the event of loan default. Advantageously, the system and method of the present invention provides reduced risk to financial institutions for non-standard automobile loans, allowing additional revenue generation for the institution. Additionally, the present invention allows financial institutions to choose to participate or not participate in loans of the program of the invention on a loan by loan basis, in contrast to participating in a portfolio of loans, thereby allowing the institution to more closely control the level of funds invested in the program.

### BRIEF DESCRIPTION OF THE DRAWINGS

FIG. 1 depicts marketing components of the present invention.

FIG. 2 depicts an overall flow 200 of the portfolio management program component of the present invention.

FIG. 3 depicts a loan application format.

FIG. 4a depicts a first portion of four criteria sets that may be employed in evaluating a loan application.

FIG. 4a depicts a second portion of four criteria sets that may be employed in evaluating a loan application.

FIG. 5 depicts loan servicing processes.

FIG. 6 depicts collections processes.

FIG. 7 depicts repossession/liquidation processes.

### DETAILED DESCRIPTION OF THE PREFERRED EMBODIMENT OF THE INVENTION

The present invention provides a system and method to assess, fund, manage, and insure non-standard loans, plus to market the functions of the present invention to financial institutions. The present invention may comprise marketing components, loan origination and portfolio management program (PMP) components as listed below.

Marketing Components

1. Development and implementation of a marketing strategy between financial institutions and automobile dealers in order to provide loans to financial institution members, automobile dealer customers, and customers seeking to purchase autos from private parties or to refinance existing auto loans.

2. Training of automobile dealers on the PMP system and encouragement to submit special financing applications to a financial service provider (FSP).

3. Assistance to financial institutions to participate in the PMP program.

Origination and PMP Components

1. Systems, procedures and credit guidelines that manage and monitor all aspects of the PMP.

2. Processing and underwriting of loans.

3. Insuring loans against borrower default on a loan-by-loan basis.

4. Performing servicing and collection of the loans.

5. Handling asset reallocation.

6. Providing a liquidity control process, which enables the financial institution to maintain total control over the amount invested in PMP loans, before and after making the loans and to recapture capital while receiving an ongoing stream of interest income.

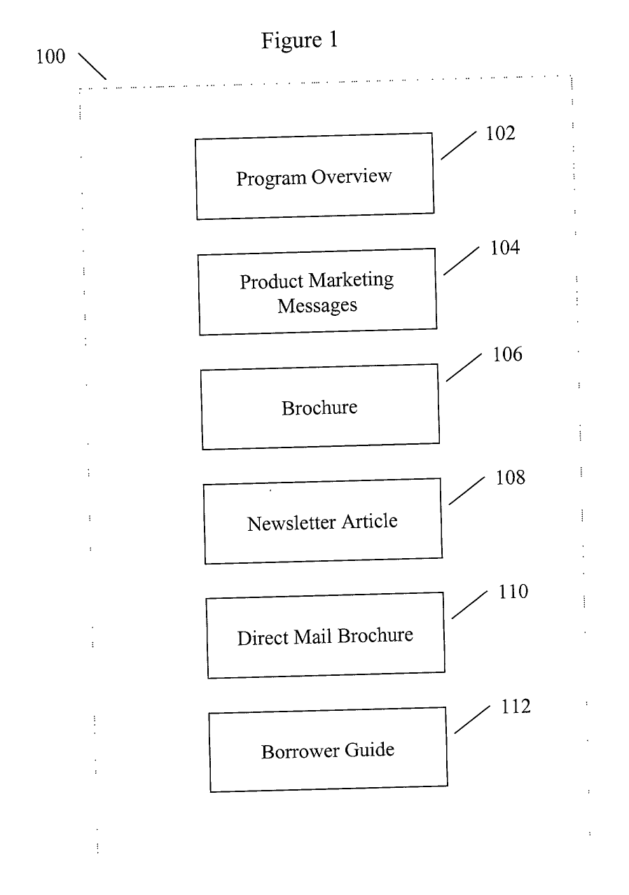

FIG. 1 depicts marketing components 100 of the present invention. Program overview 102 provides information regarding the lending and profit opportunities for financial institutions provided by the present invention. A first section may provide an overview of the non-standard automobile loan market, an overview of a company that may provide services associated with the present invention, and structure and operation of services comprising asset protection insurance, a liquidation control process, costs associated with employing the invention, and a summary of the invention. A second section may describe advantages and benefits provided to a financial institution by the present invention including up front financial guarantees, reduced risks, yield, infrastructure, systems and procedures to manage loans, appeal of the invention to automobile dealers, and the opportunity for new sources of revenue generated by the invention. A third section may describe procedures for loans originated at an automobile dealer and for loans originated at a financial institution, such as a bank or credit union, for example. A fourth section may describe organizational structure of a financial services provider implementing the present invention. The organizational structure description may describe representatives, a service center, loan underwriting, and servicing and asset reallocation. A fifth section may provide more detailed description of operation and implementation of the present invention including underwriting, portfolio management, a servicing process, a collections process, and a repossession/remarketing process.

Referring again to FIG. 1, product-marketing messages 104 may comprise messages that may be included in financial institution statements to members and telephone messages that may be rendered when a caller is on hold. A brochure 106 may be provided for lobby display. A newsletter article 108 may be utilized in a financial institution newsletter. Further, a direct mail brochure 10 may be provided. A borrower guide 112 may describe how a borrower may purchase an automobile through the method of the invention. Appendix A contains sample marketing copy for a financial institution. Appendix B contains marketing material introducing a potential borrower to a loan program of the present invention. Appendix C provides a program overview as may be presented to a credit union or other financial institution.

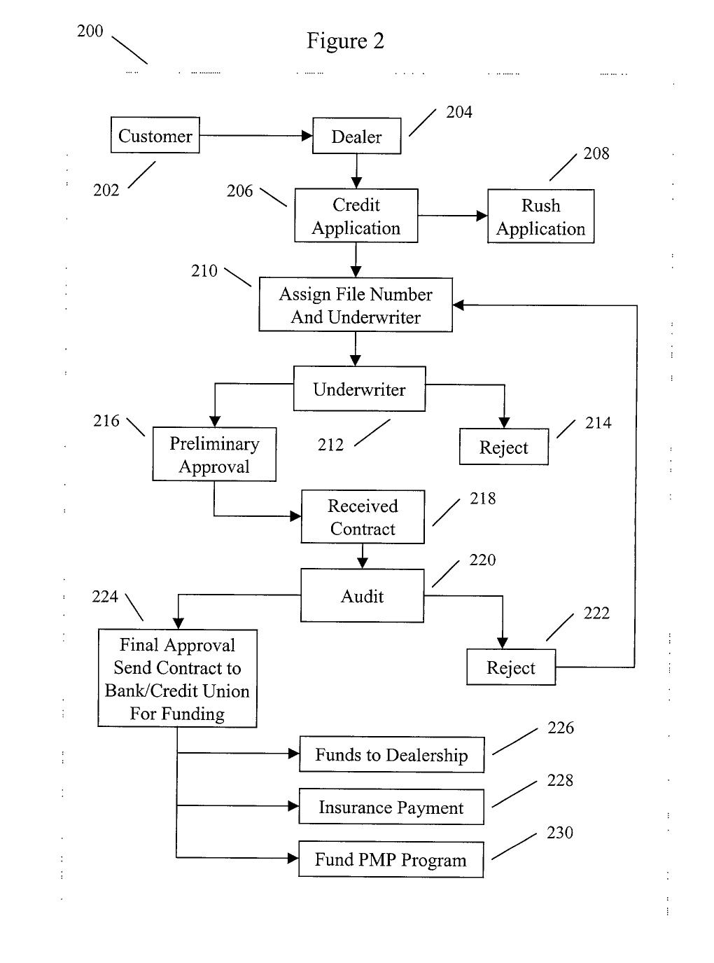

FIG. 2 depicts an overall flow 200 of the PMP component of the present invention. Customer 202 visits dealer 204 and credit application 206 may be submitted. If an automobile has been selected for purchase, a rush application 208 may be employed. At step 210, application information is submitted to a FSP (financial services provider) and an underwriter is assigned to the application. At step 212 the underwriter evaluates the application. Evaluation may employ one or more sets of predefined criteria that an application must meet in order to gain approval. At step 214, an application not meeting at least one set of criteria is rejected. If the application meets one set of criteria, preliminary approval is given at step 216. Following preliminary approval, a contract for purchasing an automobile is received at step 218. At step 220 an audit is performed to confirm information provided in the application. The audit may include evaluation of a vehicle selected for purchase. If the application and/or vehicle do not meet a set of criteria, the application is rejected at step 222. Step 222 may result in continued processing of the application at step 210 if items not meeting criteria may be corrected. If the audit finds that criteria are met, final approval is provided at step 224 and the contract is sent to a financial institution for funding. Funds are disbursed to the automobile dealer at step 226 to pay for the automobile. At step 228, funds are disbursed to purchase insurance that may protect the financial institution against loss in the event of default. At step 230, funds are disbursed to a financial services provider to fund loan origination am portfolio management provided by the FSP. The overall flow depicted in FIG. 2 comprises a customer submitting a credit application at an automobile dealer. As noted previously, a customer may make a credit application to a financial institution and, contingent on meeting a predefined set of criteria, may be provided with pre-approved credit for a specified amount.

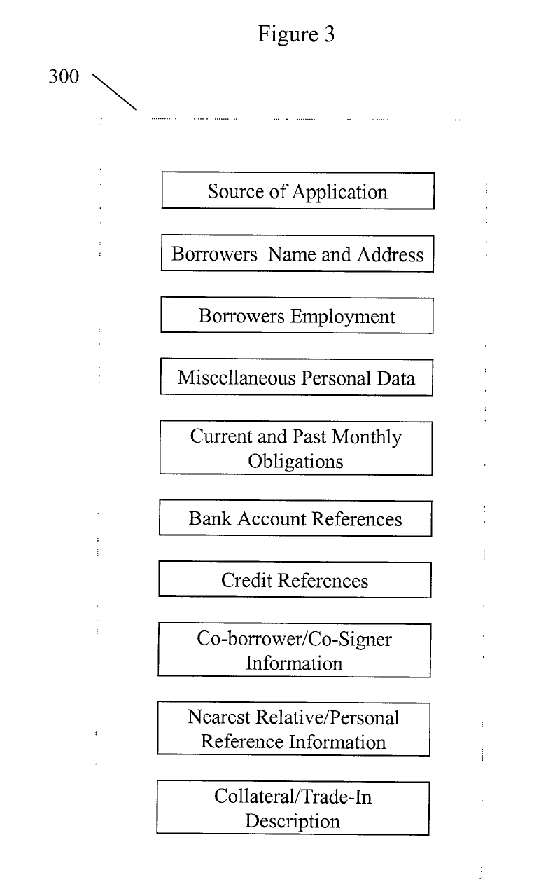

Step 206 of FIG. 2 comprises entering information in a credit application. The credit application may employ a format as shown in FIG. 3. FIG. 3 depicts a loan application 300 comprising source of application information, loan applicant personal, contact, financial and employment information categories. A common application format may be employed such that applications made at a financial institution, automobile dealership, or financial service provider office, supply a common set of information. Appendix A contains a ‘mini’ application. On-line applications, as may be supported by the Internet or other networks may be employed. Loan application data may be stored in a database. Further, the present invention may automatically order credit reports or other information, based on an applicant characteristic such as social security number, for example.

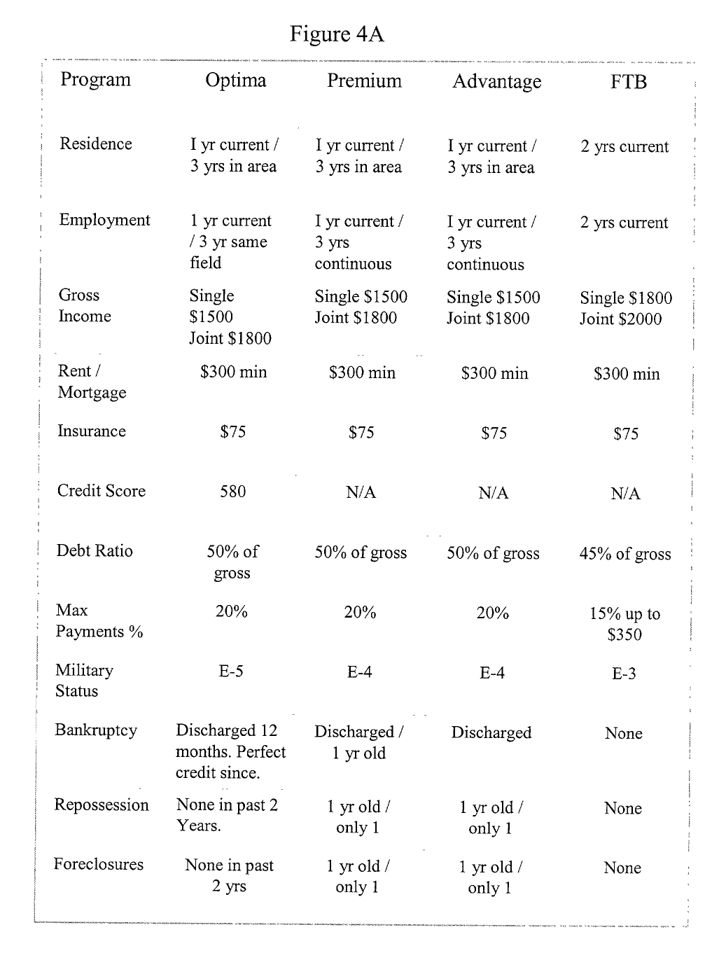

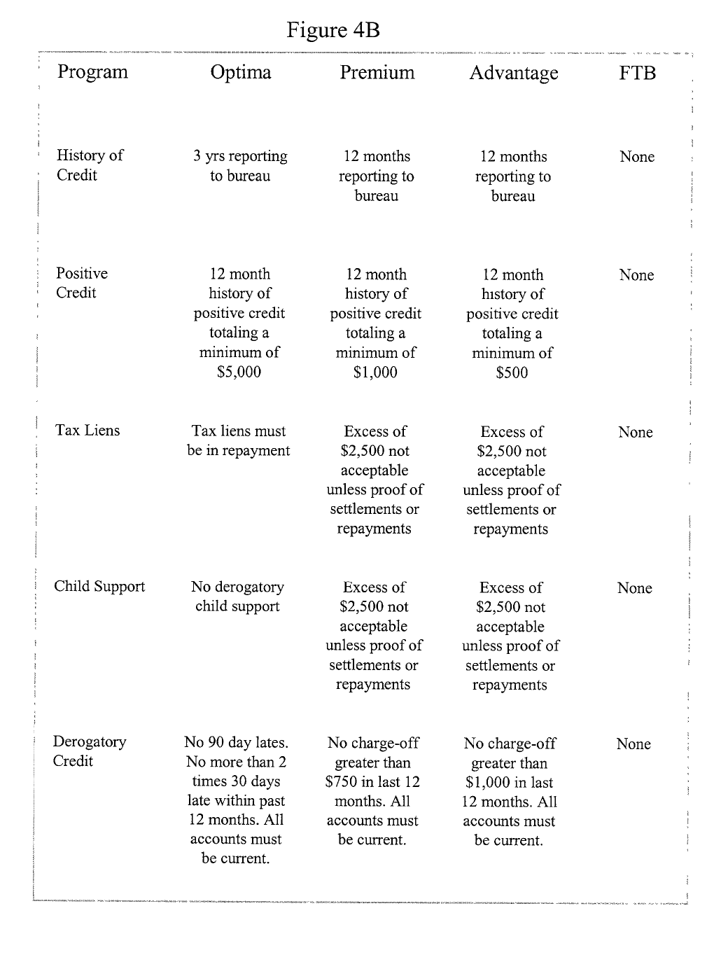

Processing of the loan application may comprise confirmation of data provided on an application. A set of criteria, or multiple sets of criteria, may be employed in determining credit application approval. FIG. 4a depicts a portion of four criteria sets. Criteria employed may include term of residence, employment history, income, housing payment, insurance payment, credit score, debt to income ratio, payment to income ratio, military status, bankruptcy history, repossession history, and foreclosure history. FIG. 4B depicts additional criteria associated with the four categories of FIG. 4A. Different terms may apply to each category, such as interest rates, down-payment requirements, and maximum loan value as a percentage of the wholesale value of an automobile, for example. A category may be tailored to a particular financial institution, or group of institutions. Terms and criteria for a category may be updated in response to performance information.

As noted in FIG. 2, funds received from a financial institution are disbursed to purchase an automobile, purchase default insurance, and to fund services associated with managing the loan. The default insurance of the present invention provides a guaranty against principal loss, that may contain limitations, and is provided, up-front, on a loan-by-loan basis by national insurance companies that have a minimum of an “A-” rating. Once issued, the coverage is non-cancelable. A single premium may cover the term of the loan. Notification of insurance coverage is provided prior to funding of a loan by a financial institution and all insurance premiums are paid at the time the loan is funded. If the financial services provider sells a loan, the default policy remains with the loan. In one embodiment, the default policy pays up to the difference between the wholesale value of the vehicle, minus a predetermined amount, and the balance owed at time of default. The policy may also pay monthly payments during a liquidation period, up to a predetermined number of payments or a predetermined maximum dollar amount. For example, a policy may be written such that it will pay up to a maximum of the difference between the wholesale value of the vehicle, minus $1,500.00, and the balance owed at time of default.

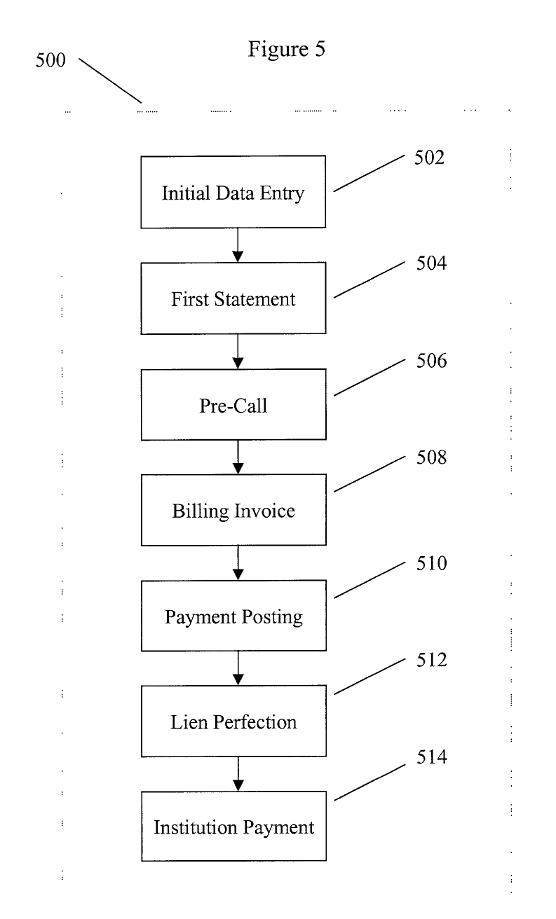

The portfolio management funded in step 230 of FIG. 2 may comprise servicing, collections and repossession/liquidation processes. As shown in FIG. 5, the servicing process 500 may comprise initial data entry 520, a first statement 504, a pre-call 506 that may welcome a borrower to the program, a billing invoice 508, payment posting 510, line perfection 512, and institution payment 514.

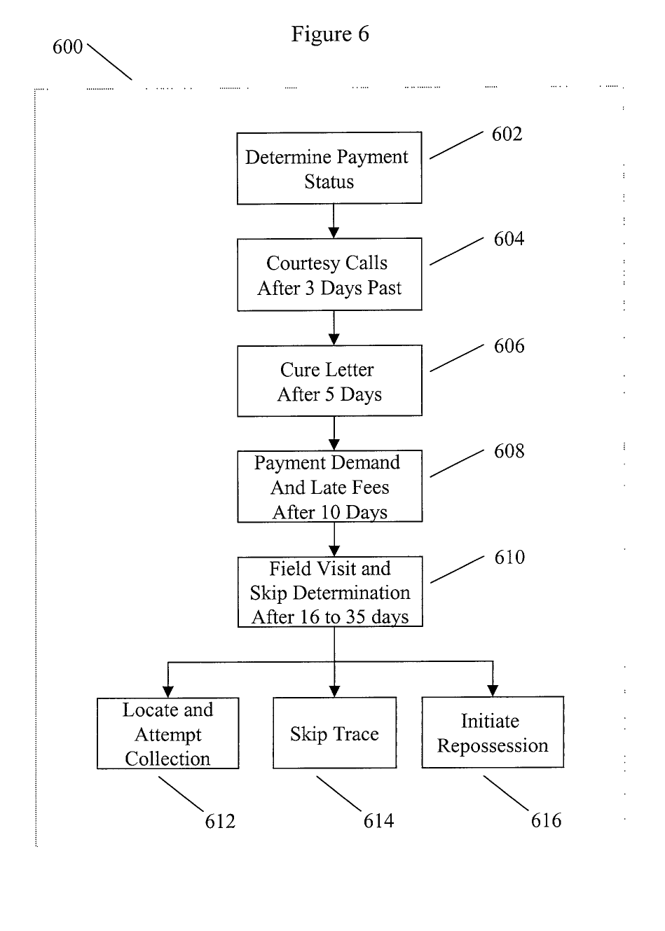

Collections processes 600 are shown in FIG. 6 and may comprise determination of payment status 602, a courtesy call 604 after 3 days, a cure letter 606 after 5 days, a demand for payment and late fees 608 after 10 days, and a field visit and skip determination 610 after 16 to 35 days. Following the field visit, the processes may comprise a locate and collection attempt 612, a skip trace 614, and initiation of repossession 616.

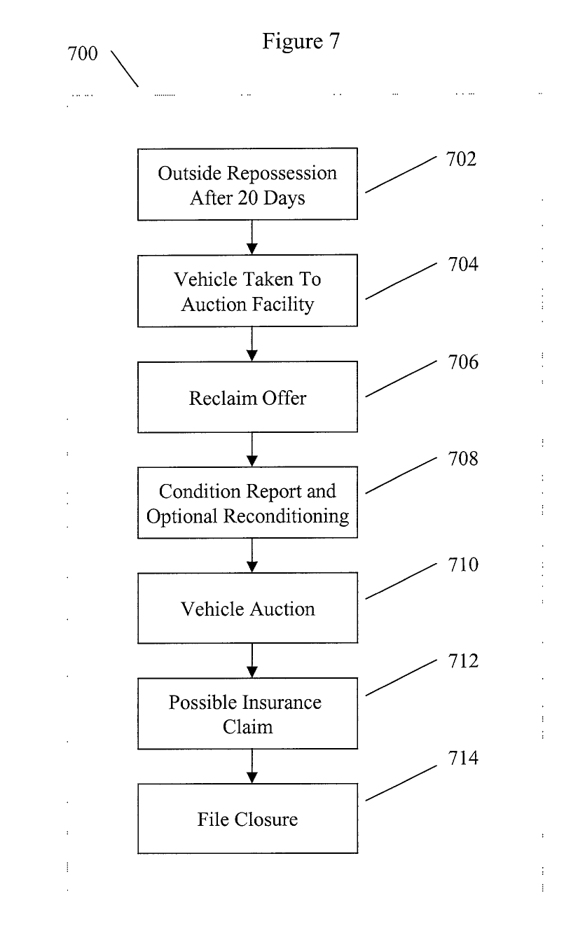

FIG. 7 depicts repossession/liquidation processes. Processes 700 may comprise outside repossession 702 after 20 days, transportation of a vehicle to an auction facility 704, a reclaim offer 716, a condition report and optional reconditioning 708, a vehicle auction 710, possible claim insurance 712, and file closure 714.

The aforementioned processes serve to provide a predetermined course of action to service, collect, or repossess/liquidate and automobile loan. The term, duration, or exact scheduling of the aforementioned processes may vary.

The present invention may comprise a liquidity control process. This allows a financial institution to control the amount of capital invested in automobile loans through the portfolio management program. Two methods may be provided. First, loans may be accepted for funding on a loan-by-loan basis, not in a portfolio, allowing a financial institution to fund as many or as few loans as desired. Secondly, a financial institution may employ a liquidity control process of the present invention. Through the liquidity control process, the financial services provider implementing the invention coordinates the sale of one or more loans held by a financial institution. Advantageously, this allows the financial institution to recapture cash from the principal of outstanding loans and may provide an ongoing source of interest income for the term of the loans sold. This may allow the financial institution to increase yields.

The present invention may employ computer-automated systems for loan entry, underwriting, loan tracking, performance monitoring, and report generation. Further, the invention may comprise resource plans, defining the systems, people and training that may be provided to implement the invention. Such resource plans may include cross training and disaster management plans to support implementation of the invention in changing or adverse conditions.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for providing financial and risk management for financial institutions comprising:
developing a marketing strategy between a financial institution and a customer;
implementing said market strategy by setting up a program including systems, procedures, and underwriting guidelines;
training said financial institution in the use of said program;
receiving a loan application from said financial institution on behalf of a customer and processing and underwriting a loan based on said loan application;
insuring said loan against default of said loan by said customer; and
managing the servicing and collecting of said loan on behalf of said financial institution.

2. The method of claim 1 wherein said step of insuring further comprises:
providing insurance coverage that is non-cancelable for the term of said loan.

3. The method of claim 1 wherein said step of implementing said marketing strategy further comprises:
establishing a disaster management plan for resources employed in managing said loan.

4. The method of claim 1 wherein said step of implementing the market strategy further comprises:
providing marketing materials to said financial institution.

5. The method of claim 4 wherein said marketing materials comprise copy for a financial institution newsletter.

6. The method of claim 4 wherein said marketing materials comprise copy for direct mail advertising of said program.

7. The method of claim 4 wherein said marketing materials comprise copy for an audio message that may be rendered when a telephone caller is on hold.

8. The method of claim 1 wherein said step of insuring the loan further comprises:
establishing an insurance policy wherein in the event of default, said insurance policy pays up to the difference between the wholesale book value of asset, minus a predetermined amount, and the balance owed for said asset at the time of default.

9. The method of claim 1 wherein said step of underwriting said loan further comprises:
applying a set of criteria to information in said application.

10. The method of claim 1 wherein said step of underwriting further comprises:
applying a limitation to the type of asset that may be financed by said loan.

11. The method of claim 1 wherein said step of managing the servicing and collecting of said loan on behalf of said financial institution further comprises:
employing predefined processes for servicing the loan, collecting payments and, in the event if default, repossessing and liquidating an asset financed by said loan.

12. A method for pre-approving automobile loans comprising:
receiving an automobile loan application;
verifying information contained in said application;
processing information contained in said application using a predefined set of criteria;
establishing loan conditions based in part on said information and said set of criteria; and
issuing a price/payment document indicating that an applicant is pre-approved and indicating the maximum monthly payment and maximum vehicle price for which said applicant may obtain a loan.

13. The method of claim 12 wherein said document is a credit-ready card.

14. A method for automobile financing comprising:
receiving applicant information;
establishing a maximum vehicle price for which an applicant may obtain financing;
assessing the value of a specific vehicle;
approving a loan for said vehicle if said value of said vehicle corresponds with a predefined set of criteria, said criteria excluding specific makes and models of automobiles, said criteria placing a limit on the ratio of vehicle price to book value, and said criteria placing limitations on the age and number of miles on said vehicle;
obtaining insurance for said loan against buyer default; and
receiving funds from a financial institution for said loan.

15. The method of claim 14 further comprising:
providing a process to said financial institution wherein said loan may be sold to a second financial institution.

16. The method of claim 14 wherein said step of receiving applicant information further comprises:
on-line entry of applicant information.

17. The method of claim 14 wherein said step of obtaining insurance further comprises:
obtaining an insurance policy wherein in the event of default, said insurance policy pays up to the difference between the wholesale book value of said vehicle, minus a predetermined amount, and the balance owed for said vehicle at the time of default

18. The method of claim 14 wherein said step of establishing a maximum vehicle price for which an applicant may obtain financing further comprises:
applying a predefined set of criteria.

19. The method of claim 14 further comprising:
managing the servicing and collecting of said loan on behalf of said financial institution.

20. The method of claim 19 wherein said step of managing further comprises:
employing predefined processes for servicing, collecting and, in the event if default, repossessing and liquidating said vehicle.

21. The method of claim 19 further comprising:
employing an automated tracking system to track loan data.
